(19) United States
(12) Patent Application Publication
(10) Pub. No.: US 2001/0050756 A1
(43) Pub. Date: Dec. 13, 2001

(54) Software generated color organ for stereoscopic and planar applications

(76) Inventors: Lenny Lipton, Greenbrae, CA (US); Robert Akka, San Francisco, CA (US)

Correspondence Address: DERGOSITS & NOAH LLP, Suite 1150, Four Embarcadero Center, San Francisco, CA, 94111, US

(21) Appl. No.: 09/876,385

(22) Filed: Jun. 7, 2001

Related U.S. Application Data
(60) Provisional application No. 60/210,346, filed on Jun. 7, 2000.

(51) Int. Cl. G03B 31/00

(52) U.S. Cl. 353/15

(57) ABSTRACT

A color organ is realized through software programming. Audio signals are input to a microprocessor-based controller. The controller then correlates an object to each audio signal on the basis of selected waveform characteristics. The object is then rendered for display on an electronic display. The display may be autostereoscopic, or it may be viewed through a stereoscopic selection device.

### BACKGROUND OF THE INVENTION

During the Twentieth Century mankind sought a means for creating a kind of “color music”—a time plastic medium for the eyes that would be comparable to music for the ears. This color music is created by means of a color organ, which may be under the instantaneous control of the color musician, just as an audio musician can control the sounds of his instrument, or a conductor the sounds of his orchestra. In some cases the color organ is instantaneously responsive to human input, most often in synchrony with music, and in other cases the organ's responses are linked, by some means, directly and automatically, to the music. Another variant can be silent color music bereft of music or audio.

There have been technological efforts in different directions to produce a color organ requiring the manipulation, and usually the projection, of light. In one approach, the entire dome of a theater or a planetarium may be covered with colored images or shapes that may or may not be synchronized with music or auditory information. The Brooklyn Paramount in New York City, for many years, had a kind of “light show” covering its ceiling. Planetariums were used for color music presentations using a laser-based organ, performed under the trade name “Laserium.”

In the 1960's and 1970's, the term light show gained currency and referred to images which were synchronized with the performance of a rock 'n roll dance band. These ever changing color images, controlled by operators, were often achieved with overhead projectors (the kind of projectors used in conference rooms for large slides) using various kinds of liquids in containers. Transparent dishes were spread out on the glass surface of the projector and food colors and water and oil based dyes were swirled together for various effects. Polarized light was also used with birefringent material to create color patterns. The results were often described as being fluid and “abstract,” “psychedelic,” or non-representational. In some cases, motion picture images, often in the form of canned loops of so-called abstract shapes, were also used in these light shows.

Yet another use of the term color organ has referred to a device having pedals or a keyboard like an organ, which a person could manipulate and which could, as stated above, be synchronized to music, or simply be free-form without music.

A number of artists over the years have been interested in the general concept of these kinds of color moving shapes. Tomas Wilfred's “Lumia,” which was his term for a moving color projection, was a beautiful kind of light sculpture. One was on display for many years in the Museum of Modern Art in New York City. Light was reflected off various surfaces that were moved with a kind of clockwork motor, and there were various additive-color combinations of shapes and colors. The entire presentation, which was not synchronized to music, repeated cyclically but had a long period of many hours. The result was a fascinating and beautiful art object that could be viewed indefinitely if one had a mind to and was interested in meditating on an ever-changing abstract color fantasy. Wilfred's work is representational of the field in that the images are “non-representational” or what is sometimes described as “abstract” or “free-form.” Possibly the best work of the medium is ineffable and defies categorization and description.

In addition, there have been artists who have been interested in producing images that were strongly related to the esthetic of the color organ. Oskar Fischinger was an artist who created a motion picture animated form that showed images metamorphosing through time. Fischinger used the technique of a wax block of mixed colors that he sliced progressively and animated by photographing a frame at a time. By showing the progressive changes in cross-section of the sliced block, changes in color and shapes were achieved, a slice at a time, which when projected appeared to be fluid.

There have been other artists—particularly a few who lived in California including James Whitney, Jordan Belson, and Harry Smith—who were influenced by color organ technology and were apparently also influenced by eastern thought and eastern religion.

Today, a person interested in obtaining a color organ can still search the Internet and find electronics kits of parts for producing color organs. All of these kits have their technology imbedded in firmware and have relatively simple optical origins with moving colored filters and the like.

In the last twenty years or so the following U.S. Patents have been issued on the subject:

U.S. Pat. No. 4,928,568—Color Organ Display Device

U.S. Pat. No. 4,645,319—Composite Optical Image Projection System

U.S. Pat. No. 4,386,550—Optically Coupled Decorative Light Controller

U.S. Pat. No. 4,265,159—Color Organ

U.S. Pat. No. D255,796—Wall Mounted Music-Responsive Color Organ

U.S. Pat. No. 4,000,679—Four-Channel Color Organ

In studying these patents it is interesting to note that none of the technology in the aforementioned prior art is based on microprocessor technology, which renders these disclosures virtually obsolete, first, because computer technology allows for a greater number of more visually interesting images to be generated than what these aforementioned patents aim to deliver, and second, because just about everything in these patents can now be emulated with computer architecture and software/firmware. Therefore, the computer with a monitor or video projector is a viable means for producing interesting color images. Thus, a computer programmed with the proper software routine or application can become the most flexible color organ imaginable.

To the best of our knowledge, there have been no disclosures aimed at using a modern computer or PC to produce a color organ effect that might be operator controlled or synchronized to sounds or music. In addition, it seemed to the inventors that adding the stereoscopic depth effect would also be beneficial. The images can be formatted to produce a result that can be viewed with the standard modern electronic stereoscopic viewing means, namely occluding eyewear such as CrystalEyes® eyewear products sold by StereoGraphics Corporation of San Rafael, Calif. Other stereoscopic viewing means, such as autostereoscopic lenticular displays, are possible, and these and others are well known to the practitioners of the art and need not be spelled out here in any detail.

The following disclosure sets forth means whereby computer generated color organ images can be achieved.

### SUMMARY OF THE INVENTION

The invention includes several approaches that utilize stereoscopy on a computer system to visually represent audio input. In all of these approaches, one or more aspects of the audio signal are interpreted and represented using techniques that may be perceived visually. The resulting imagery is made stereoscopic using one or more of three techniques.

These three techniques for using stereoscopy in representing audio graphically are:

1) Creating a three-dimensional scene that includes an interpretation of the audio signal, and rendering that three-dimensional scene stereoscopically;

2) Laying out two-dimensional scene elements that include an interpretation of the audio signal, and creating a stereoscopic effect by applying horizontal offsets to left-eye and right-eye components of those scene elements; and

3) Laying out two-dimensional scene elements that include an interpretation of the audio signal, and creating a stereoscopic effect by applying horizontal morph effects to those scene elements.

These three techniques may be used individually or together, in combination with different audio interpretation techniques and different graphical representation techniques.

### BRIEF DESCRIPTION OF THE DRAWINGS

FIG. 1 is a block diagram of the overall system.

FIG. 2 illustrates stereoscopic rendering of a three-dimensional scene.

FIG. 3 illustrates a technique in which simple horizontal image element shifting is used to introduce a stereoscopic effect.

FIG. 4 shows a technique in which stretching one eye's component of an image element is used to introduce a stereoscopic effect.

FIG. 5 is a flowchart illustrating the correlation of an audio signal to a predefined object.

### DETAILED DESCRIPTION OF THE INVENTION

The invention shown in FIG. 1 consists of a computer system 102 running computer software that takes an audio signal 101 as input, and produces stereoscopic visual imagery on a display device 103. In most implementations that are not autostereoscopic, the system would also need to include a stereoscopic selection device 104, such as shuttering eyewear. The audio signal 101 could derive from an external device, or from storage or software on the computer system 102, or from a data source such as the Internet that the computer system 102 is connected to.

This invention may utilize any of a number of approaches to convert audio input. Each approach is realized by programming instructions into computer system 102. Two types of instructions are required: one for analyzing the audio input and associating an object and color with it, and another for rendering the object. Such programming is routine and within the ordinary skill of those working in this technology area.

One method for converting the audio input is to interpret amplitude or loudness. The amplitude being interpreted could be the overall amplitude, or a range of frequency-specific amplitudes. Different sound frequencies in the audio signal could be interpreted graphically in a variety of ways. Stereoscopically rendered two-dimensional shapes or three-dimensional objects could vary in size or position, according to the amplitudes of particular audio frequencies that each colored object corresponds to. Or, using a less abstract method, the audio waveform could be represented as a colorful three-dimensional graph, rendered stereoscopically.

Another method that could be utilized would involve the recognition of repeating patterns, such as a musical beat. For example, a rotating or pulsating three-dimensional figure could synchronize itself to the cycle of a repeating pattern in the audio signal.

Complex audio waveforms might be recognized as corresponding to a particular musical instrument, such as a trumpet, or a particular musical style, such as country music. The computer software could respond to this recognition by tailoring the graphical imagery to match a theme that corresponds to that musical instrument or musical style.

Significant, sudden changes with respect to any of the above audio attributes, could trigger special stereoscopic visual effects. For example, the computer software could switch to an entirely different method of displaying stereoscopic imagery, in response to a shift in the musical tempo.

There are numerous graphical qualities that could be used to represent any of the attributes that are detected from the computer software's analysis of the audio input stream. For example, computer software could display variations of color, based on the audio signal. Similarly, two-dimensional shapes or three-dimensional objects could vary in shape or size, based on changes detected in the audio signal.

Some aspects of the audio signal could control the number of objects represented in the scene, as well. In fact, there could be many very small objects in the scene, corresponding to some quality of the audio that the computer software interprets.

Variations of three-dimensional depth, represented stereoscopically, could be tied to some aspect of the audio input. Three-dimensional or two-dimensional position, rotation, and/or scaling transformations that determine how particular scene elements appear could be affected by a computer software interpretation of the audio signal. Motion effects in the stereoscopically displayed scene could be based on qualities of the audio input as well. Objects or images in the stereoscopically displayed scene could be distorted based on the audio input.

Yet another general approach for visually representing audio input would be to use animal or human-like character representations, which might be synchronized to the audio signal. Computer software would display these characters stereoscopically.

Computer software could maintain a database of different bitmaps, animation sequences, and/or three-dimensional objects, which the computer software could draw for presenting interesting graphical effects in response to the audio input.

Graphical representations of the audio waveform, whether two-dimensional or three-dimensional, could be utilized as part of the visual display.

Variations of the three-dimensional rendering parameters, such as virtual camera positioning or orientation, could be affected by interpretation of attributes of the audio signal. Additionally, the computer software could affect variations of the stereoscopic rendering parameters, based on the audio signal. For example, stereoscopic virtual camera separation and/or stereoscopic parallax balance could be varied based on changing attributes of the audio input.

Finally, the stereoscopic graphical display could include visual elements that have nothing to do with the audio signal.

The computer software that interprets the audio signal and controls the visual display should be configurable to allow many different approaches, including some mentioned above, so that the user could pick from some of the most interesting audio interpretation methods and visual effects. A versatile user interface should give the user the ability to configure combinations of visual effects in a variety of interesting ways. In this way the user is able to express him or herself by selecting appropriate shapes and colors to represent moods and visual styles most appropriate to the musical composition. Indeed, a versatile user interface would allow the user to play color organ compositions independently of music.

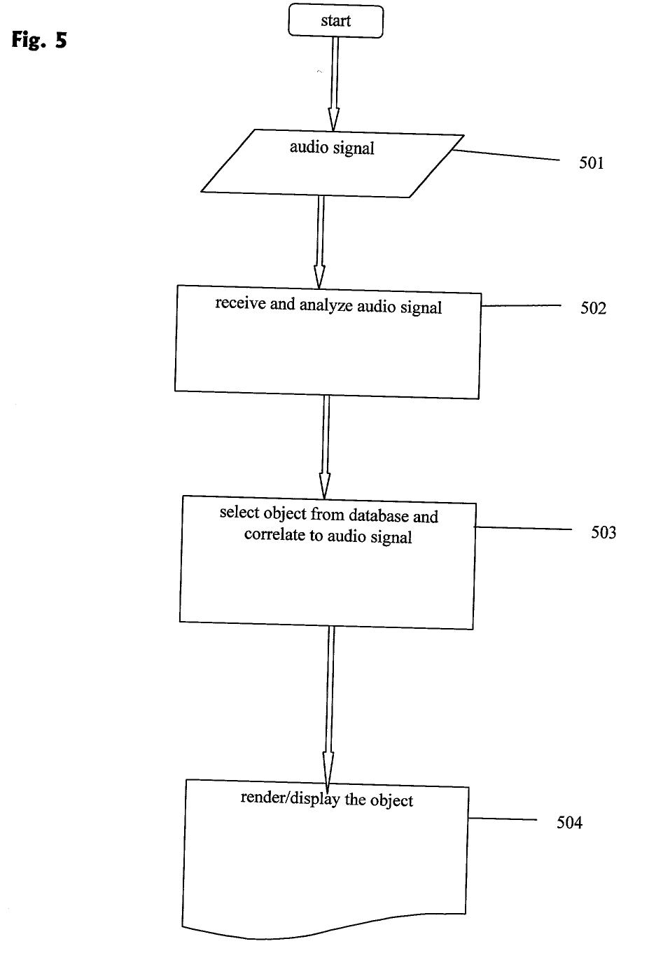

For example, FIG. 5 is a simple flow chart that can be realized through many different programming examples, all of which would be routine for one with ordinary skill in this technology. In step 501, at least one audio signal is identified as an input to the system. In step 502, the microprocessor receives and analyzes the audio input. In step 503, the microprocessor selects an object from a database and correlates that object to the audio signal. The correlation may be in accord with any one of a number of schemes as described herein. For example, a first audio signal having an amplitude of A may be predetermined to have a correlation with object X. Likewise, a second audio signal having an amplitude of B may be predetermined to have a correlation with object Y, and so on. In step 504, the object is rendered and sent for display on an electronic display.

In addition to the assorted approaches to interpreting audio information to generate visual effects, as described above, the invention includes three general approaches to displaying these visual effects stereoscopically. Descriptions of these three approaches follow.

The first approach to displaying graphical scenes, which are based on audio input, stereoscopically, is stereoscopic three-dimensional rendering.

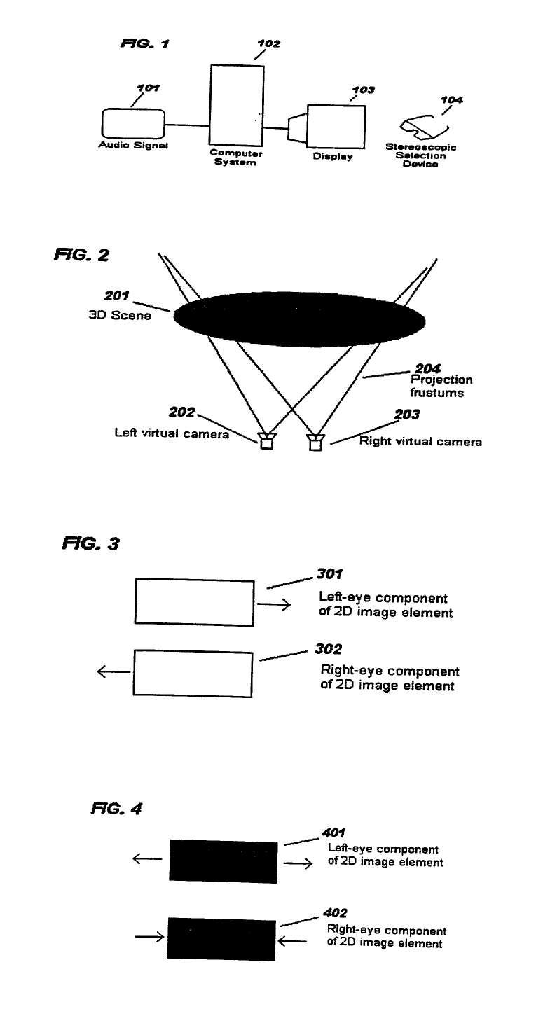

In this approach (FIG. 2), software creates and maintains a three-dimensional scene or model 201, based on an interpretation of the audio signal. This scene or model is then rendered, in real-time, with both left-eye and right-eye views. The best way to do the two-eye-view stereoscopic rendering is to set up two virtual cameras (centers of projection) 202 and 203 with an offset that is perpendicular to both the original camera-target vector and the original rendering up-vector. For best results, the two stereoscopic renderings (one for each eye's view) should use perspective projections with parallel camera-target vectors. Those projections should have frustums 204 that are asymmetric along their shared horizontal axis, such that the plane of zero (balanced) parallax is somewhere within the region of interest in the three-dimensional scene.

One example of this first approach to creating stereoscopic scenes might be a field of many textured three-dimensional polyhedrons, which float around in space in response to an interpretation of audio input, and which are rendered stereoscopically. Another example: an animated three-dimensional character that appears to dance to the beat of the music, as interpreted from the audio input, rendered stereoscopically. Yet another example would be for the computer software to represent the audio signal spatially as a three-dimensional surface, and to render that scene stereoscopically.

Means for linking differences between sound channels in multi-channel or stereophonic sound can be employed based on variations of techniques described herein. One possible example of this would be to have one audio channel correspond to one range of colors and for the other audio channel correspond to a different range of colors. Another example would be for graphical imagery to appear towards one side of the display or the other, depending on whether the sound information comes from one audio channel, the other, or both.

The second approach to doing a stereoscopic representation of a scene is to apply stereoscopic offsets to two-dimensional shaped scene elements. If one applies a horizontal offset to a two-dimensional object's representation in the two eyes' views, the viewer will interpret that offset as stereoscopic parallax, which affects the viewer's perception of that object's depth position. For example (see FIG. 3), if we apply a slight stereoscopic offset to a rectangle, such that its left-eye representation 301 is shifted slightly to the right relative to its right-eye representation 302, the rectangle will appear to be spatially closer than if there was no offset. The two-dimensional objects being offset could be shapes such as the rectangle in the above example, or two-dimensional regions containing bitmapped textures.

An example of this approach would be to display a collection of colored two-dimensional shapes, which float around at different stereoscopic depths. These different stereoscopic depths would be effected using variations of horizontal offset values, based on interpreted audio input. Another example would be a matrix of textured shapes, with the left-eye and right-eye components offset by different amounts relative to each other. This would result in a stereoscopic effect in which different parts of the scene appear to have different depths, based on an interpretation of the audio signal.

The third approach to doing a stereoscopic representation of a scene is to apply a horizontal morph effect to two-dimensional textured scene elements. This third approach is similar to the second approach (stereoscopic offsets to two-dimensional shaped scene elements), except that the horizontal offset, of one eye's view relative to the other, is variable across the width and/or height of a given two-dimensional object.

For example (refer to FIG. 4), a very simple morph effect would be to horizontally stretch the left-eye view of an object 401 relative to the right-eye view of that object 402. Thus, the left edge of that object (having one offset value) would appear to be farther away than the right edge of that object (which has a different offset value), and the rest of the object in between would appear to span the range of depth between the two edges. With a more complicated morph pattern (the morphed offsets should always be horizontal, but the amount of offset could vary in both horizontal and vertical directions), a textured object could appear to have a more complicated depth pattern, perhaps resembling a three-dimensional landscape.

Thus, there could be a single full-screen texture map, with the left eye's component representation distorted horizontally relative to that of the right eye. This could result in an interesting three-dimensional surface effect, with stereoscopic depth effects responding to the interpreted audio input.

A more complex example of this approach would be to display various textured two-dimensional shapes. A morph effect could then be used to continuously distort their originally planar appearance, in response to interpreted audio input, resulting in interesting stereoscopic effects.

Any of the three above approaches to doing a stereoscopic representation of a scene could be used alone, or in combination with other approaches. For example, the display could include three-dimensional objects that are stereoscopically rendered using perspective projection, mixed with two-dimensional shapes positioned at various depths using simple offset, with a background texture that uses the morph technique to achieve a variable-depth effect.

Additionally, any of these approaches to stereoscopic representation could be combined with any of the methods for interpreting qualities of the audio input into visual imagery.

User interface would be provided to allow the user to configure the computer software to select different combinations of audio input interpretation methods, visual display options, and approaches to making the visual imagery stereoscopic.

We claim:

1. A color organ system, comprising:
at least one audio signal input having waveform characteristics,
a microprocessor-based controller receiving the audio signal input and generating a graphical output having a color attribute in response to a waveform characteristic of the audio signal, and
an electronic display coupled to the controller for displaying the graphical output.

2. A color organ system as in claim 1, wherein the graphical output is a stereoscopically rendered image.

3. A color organ system as in claim 2, wherein the electronic display is autostereoscopic.

4. A color organ system as in claim 2, further comprising a stereoscopic selection device for observing the display.

5. A color organ system as in claim 1, wherein the waveform characteristic is amplitude, and wherein the graphical output is an object rendered in proportion to the amplitude.

6. A color organ system as in claim 5, wherein the object is rendered to have a size in proportion to the amplitude.

7. A color organ system as in claim 5, wherein the object is rendered to have a position in proportion to the amplitude.

8. A color organ system as in claim 5, wherein the object is rendered to have color attributes having a relation to the amplitude.

9. A color organ system as in claim 1, wherein the waveform characteristic is frequency, and wherein the graphical output is an object rendered in proportion to the frequency.

10. A color organ system as in claim 5, wherein the object is rendered to have a size in proportion to the frequency.

11. A color organ system as in claim 5, wherein the object is rendered to have a position in proportion to the frequency.

12. A color organ system as in claim 1, wherein the controller includes a store having a plurality of predefined objects for use as the graphical output, and wherein one of said objects is selected in response to the waveform characteristic of the audio signal.

13. A color organ system as in claim 12, wherein one of said objects is selected automatically by the controller.

14. A color organ system as in claim 12, wherein one of said objects is selected manually by a user.

15. A color organ system as in claim 12, wherein said predefined objects include predefined bitmaps.

16. A color organ system as in claim 12, wherein said predefined objects include predefined animation sequences.

17. A color organ system as in claim 12, wherein said predefined objects include predefined two dimensional shapes.

18. A color organ system as in claim 12, wherein said predefined objects include predefined three dimensional shapes.

19. A method of generating color organ effects, comprising the steps of:
coupling at least one audio signal having waveform characteristics as an input to a microprocessor-based controller,
generating a graphical output having at least one color attribute in response to a waveform characteristic of the audio signal, and
displaying the graphical output on an electronic display.

20. A method as in claim 19, wherein the graphical output is generated as a stereoscopically rendered image.

21. A method as in claim 20, wherein the electronic display is autostereoscopic.

22. A method as in claim 20, further comprising observing the display through a stereoscopic selection device.
